(19) United States
(12) Patent Application Publication
(10) Pub. No.: US 2019/0128171 A1
(43) Pub. Date: May 2, 2019

(54) COOLING STRUCTURE FOR VEHICLE

(71) Applicant: HONDA MOTOR CO., LTD., Tokyo (JP)

(72) Inventors: Tatsuya KURIMOTO, Wako-shi (JP); Yusuke NARA, Wako-shi (JP); Kenji SAITO, Wako-shi (JP); Wataru INOUE, Wako-shi (JP)

(21) Appl. No.: 16/155,215

(22) Filed: Oct. 9, 2018

(30) Foreign Application Priority Data
Oct. 31, 2017 (JP) 2017-210906

(51) Int. Cl. F01P 3/12; B60K 6/22; B60K 11/04; F01P 3/20; B60H 1/00; B60H 1/08; B60H 1/32

(52) U.S. Cl. CPC F01P 3/12; B60K 6/22; B60K 11/04; F01P 3/20; B60H 1/004; B60Y 2306/05; B60H 1/00571; B60H 1/08; B60H 1/3227; B60Y 2200/92; B60H 1/00328

(57) ABSTRACT

A cooling structure includes: a first heat exchanger including a first heat dissipating portion configured to cool coolant for a first device and a second heat dissipating portion configured to cool coolant for a second device, the first and second heat dissipating portions being arranged along a plane facing in a fore and aft direction with respect to the vehicle and constituting a unitary structural body extending along the plane facing in the fore and aft direction; and a second heat exchanger including a third heat dissipating portion configured to cool coolant for a third device, the third heat dissipating portion extending along the plane facing in the fore and aft direction and being disposed in front of the first heat exchanger to overlap with a part of the first heat exchanger as seen in the fore and aft direction.

### TECHNICAL FIELD

The present invention relates to a cooling structure for a vehicle for cooling devices mounted on the vehicle.

### BACKGROUND ART

An automobile has various heat-generating devices mounted thereon, and to cool the heat-generating devices, is provided with multiple heat exchangers, which may be also referred to as radiators, coolers, or condensers. In hybrid electric vehicles (HEVs) having an internal combustion engine and an electric motor mounted thereon as power sources, a heat exchanger for cooling the electric drive system and a heat exchanger (air conditioning condenser) for cooling the air conditioning system are necessary in addition to a heat exchanger (radiator) for cooling the internal combustion engine. Further, in turbo vehicles equipped with a supercharger, a heat exchanger (intercooler) for cooling compressed air is also necessary.

JP3862547B discloses a cooling system for a hybrid electric vehicle, which includes a first radiator for cooling a DC/DC converter and an electric drive system, a second radiator for cooling an internal combustion engine, and an air conditioning (A/C) condenser, wherein the air conditioning condenser, the first radiator, the second radiator, and a fan are arranged in a row in this order. The first radiator, the second radiator, and the A/C condenser (which may be summarily referred to as heat exchangers) each have a heat dissipating portion formed in a plate shape, and are disposed such that the heat dissipating portion faces forward to allow an air flow caused by traveling of the vehicle to flow across the heat dissipating portion easily. As a result, these heat exchangers are arranged in a row in the fore and aft direction.

However, in the cooling system for a vehicle disclosed in JP3862547B, because the heat exchangers (air conditioning condenser, first radiator and second radiator) are arranged in a row, the system has a large dimension in the direction of arrangement of the heat exchangers (typically, in the fore and aft direction), and therefore, it is necessary to increase the dimension of the engine room in the fore and aft direction. Further, the number of components is large, which can result in high cost.

### SUMMARY OF THE INVENTION

In view of such background, a primary object of the present invention is to provide a cooling structure for a vehicle that can reduce the dimension of the engine room in the fore and aft direction, while reducing the cost.

To achieve such an object, one embodiment of the present invention provides a cooling structure for a vehicle (1), comprising: a first heat exchanger (11) including a first heat dissipating portion (41A) configured to cool coolant for a first device (4, 5) and a second heat dissipating portion (41B) configured to cool coolant for a second device (7), the first and second heat dissipating portions being arranged along a plane facing in a fore and aft direction with respect to the vehicle and constituting a unitary structural body (41) extending along the plane facing in the fore and aft direction; and a second heat exchanger (12) including a third heat dissipating portion (61) configured to cool coolant for a third device (8), the third heat dissipating portion extending along the plane facing in the fore and aft direction and being disposed in front of the first heat exchanger to overlap with a part of the first heat exchanger as seen in the fore and aft direction.

According to this arrangement, because the first heat dissipating portion and the second heat dissipating portion are unitarily provided in first heat exchanger, the number of components is reduced, and hence, the cost is reduced. Further, because the first and second heat dissipating portions of the first heat exchanger are arranged along the plane facing in the fore and aft direction and the third heat dissipating portion is disposed in front of the first heat exchanger to overlap with a part of the first heat exchanger as seen in the fore and aft direction, the dimension of the cooling structure in the fore and aft direction can be reduced compared to the case where the three heat dissipating portions are respectively provided in separate heat exchangers arranged in a row in the fore and aft direction.

In the above arrangement, preferably, a target temperature (e.g., 60° C.) of the second heat dissipating portion (41B) is lower than a target temperature (e.g. 90° C.) of the first heat dissipating portion (41B), and the third heat dissipating portion (61) is disposed at a position where the third heat dissipating portion substantially overlaps with the first heat dissipating portion and substantially does not overlap with the second heat dissipating portion as seen in the fore and aft direction.

According to this arrangement, because substantially no part of the third heat dissipating portion overlaps with the second heat dissipating portion, the second heat dissipating portion can easily attain the target temperature lower than the target temperature of the first heat dissipating portion.

In the above arrangement, preferably, the first heat dissipating portion (41A) constitutes a heat dissipating portion configured to cool cooling liquid for an internal combustion engine (4), the second heat dissipating portion (41B) constitutes a heat dissipating portion configured to cool cooling liquid for a power control unit (7), and the third heat dissipating portion (61) constitutes a core of an air conditioning condenser (12) configured to condense air conditioning coolant.

According to this arrangement, the coolant flowing through the first heat dissipating portion and the coolant flowing through the second heat dissipating portion are both cooling liquid. Therefore, even if a damage is caused to the first heat exchanger resulting in mixture of the cooling liquids, an adverse effect caused thereby can be small compared to a case where one of the coolants for the first and second heat dissipating portions is gas. Further, the power control unit can be maintained at a temperature lower than that of the internal combustion engine.

In the above arrangement, preferably, the first heat exchanger (11) includes an upper tank (42) provided above the first heat dissipating portion (41A) and the second heat dissipating portion (41B) and a lower tank (43) provided below the first heat dissipating portion (41A) and the second heat dissipating portion (41B), each of the upper and lower tanks has a partition wall (45, 50) provided at a position corresponding to a boundary between the first heat dissipating portion (41A) and the second heat dissipating portion (41B) to divide an interior of the tank into a first chamber (46, 51) communicating with the first heat dissipating portion and a second chamber (47, 52) communicating with the second heat dissipating portion.

According to this arrangement, the pair of tanks, each having an interior divided into first and second chambers by the corresponding partition wall, can be used commonly for the first and second heat dissipating portions, and therefore, the number of components is reduced, which reduces the cost.

In the above arrangement, preferably, one (42) of the upper and lower tanks is connected with a first cooling liquid feed pipe (21) for feeding cooling liquid to the first chamber (46) thereof and a second cooling liquid feed pipe (26) for feeding cooling liquid to the second chamber (47) thereof, the other (43) of the upper and lower tanks is connected with a first cooling liquid discharge pipe (22) for discharging the cooling liquid from the first chamber (51) thereof and a second cooling liquid discharge pipe (27) for discharging the cooling liquid from the second chamber (52) thereof, and a downstream end portion (48) of the first cooling liquid feed pipe is connected to a part of the first chamber (46) offset toward the second chamber (47) and is inclined relative to the fore and aft direction in such a manner that the downstream end portion extends obliquely away from the second chamber (47) toward a front.

According to this arrangement, the first cooling liquid feed pipe can be placed near the second cooling liquid feed pipe, and therefore, the cooling structure can be made compact. Further, because the downstream end portion of the first cooling liquid feed pipe is inclined in such a manner that the downstream end portion extends obliquely away from the second chamber toward the front, the cooling liquid can easily flow to a part of the first heat dissipating portion located opposite from the direction in which the downstream end portion is offset. Thereby, the cooling liquid can flow evenly through the first heat dissipating portion, and this suppresses reduction in the heat dissipation efficiency that could be caused by the offsetting of the downstream end portion of the first cooling liquid feed pipe.

In the above arrangement, preferably, the second heat exchanger (12) is mounted to the first heat exchanger (11), and the first heat exchanger is mounted to a vehicle body (2).

According to this arrangement, the second heat exchanger is mounted to the first heat exchanger to form a module, and this module can be mounted to the vehicle body. Thus, the mounting of the components to the vehicle body can be facilitated.

Preferably, the cooling structure further comprises a protective member (70) mounted to the first heat exchanger (11) to be located in front of the second heat dissipating portion (41B).

According to this arrangement, not only the first heat dissipating portion protected by the third heat dissipating portion, but also the second heat dissipating portion can be protected by the protective member. Thereby, both of the first and second heat dissipating portions for cooling the first and second devices can be protected.

Preferably, the cooling structure further comprises a pair of fans (13L, 13R) arranged side by side in a lateral direction behind the first heat exchanger (11), wherein one (13L) of the pair of fans located on a side of the second heat dissipating portion overlaps with the second heat dissipating portion (41B) and the first heat dissipating portion (41A) as seen in the fore and aft direction.

According to this arrangement, it is unnecessary to provide fans dedicated for the first heat dissipating portion and the second heat dissipating portion, respectively, and the fans can be embodied by general purpose products. Therefore, the cost can be further reduced.

Thus, according to an embodiment of the present invention, it is possible to provide a cooling structure for a vehicle that can reduce the dimension of the engine room in the fore and aft direction, while reducing the cost.

### BRIEF DESCRIPTION OF THE DRAWINGS

FIG. 1 is a circuit block diagram of a cooling structure for a vehicle according to an embodiment of the present invention;

FIG. 2 is a perspective view of a main part of the cooling structure shown in FIG. 1;

FIG. 3 is a front view of the cooling structure shown in FIG. 2;

FIG. 4 is a rear view of the cooling structure shown in FIG. 2;

FIG. 5 is a plan view of the cooling structure shown in FIG. 2;

FIG. 6 is a left side view of the cooling structure shown in FIG. 2; and

FIG. 7 is a front view of a radiator shown in FIG. 3.

### DESCRIPTION OF THE PREFERRED EMBODIMENT(S)

In the following, a preferred embodiment of the present invention will be described in detail with reference to the drawings. In the following description, front, rear, left, and right are defined with respect to the traveling direction of an automobile 1. Up and down are defined with respect to the vertical direction.

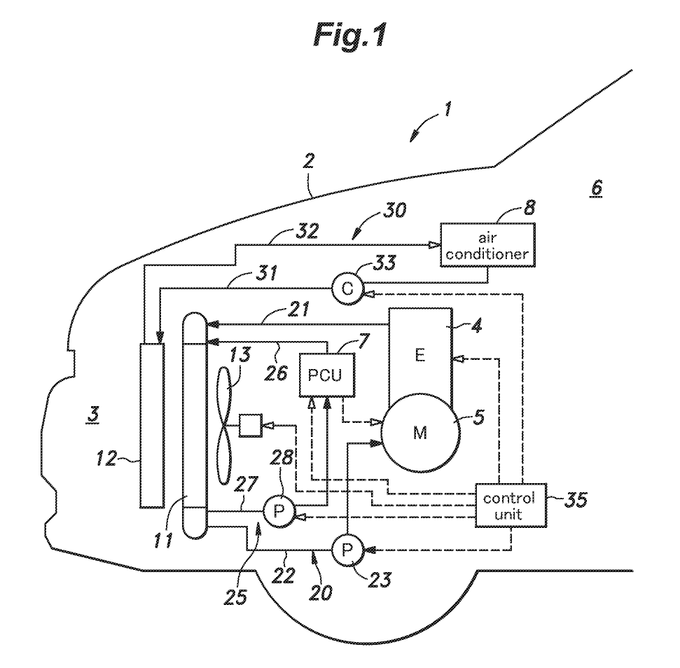

FIG. 1 is a circuit block diagram of a cooling structure for a vehicle according to an embodiment of the present invention. As shown in FIG. 1, the automobile 1 has an engine room 3 defined in a front part of a vehicle body 2, and is embodied as a hybrid vehicle equipped with an engine 4 consisting of an internal combustion engine and an electric motor 5, which are mounted in the engine room 3, as power sources for driving the vehicle. The automobile 1 is further provided with a power control unit (PCU) 7 for controlling power supply from a battery to the electric motor 5 and an air conditioner 8 for conditioning air in a passenger compartment 6, which are also mounted in the engine room 3. In a front part of the engine room 3, a radiator 11 is mounted to a bulkhead provided in the front part of the vehicle body 2. An air conditioning condenser 12 is disposed in front of the radiator 11, and a radiator fan 13 is disposed behind the radiator 11, where the air conditioning condenser 12 and the radiator fan 13 are both attached to the radiator 11.

In the engine room 3, a first cooling circuit 20 for cooling the engine 4 and the electric motor 5 is provided. The first cooling circuit 20 includes a first cooling liquid feed pipe 21 connecting the engine 4 and the electric motor 5 with the radiator 11 to feed cooling liquid serving as coolant to the radiator 11, and a first cooling liquid discharge pipe 22 connecting the radiator 11 with the engine 4 and the electric motor 5 to discharge the cooling liquid from the radiator 11. A first electric pump 23 is provided in the first cooling liquid discharge pipe 22. In the first cooling circuit 20, the cooling liquid pumped by the first electric pump 23 to circulate in the circuit absorbs heat from the engine 4 and the electric motor 5 and dissipates heat to ambient air (or exchanges heat with ambient air) at the radiator 11, to thereby cool the engine 4 and the electric motor 5. It is to be noted that the first electric pump 23 may be provided in the first cooling liquid feed pipe 21.

Also provided in the engine room 3 is a second cooling circuit 25 for cooling the power control unit 7. The second cooling circuit 25 includes a second cooling liquid feed pipe 26 connecting the power control unit 7 with the radiator 11 to feed cooling liquid serving as coolant to the radiator 11, and a second cooling liquid discharge pipe 27 connecting the radiator 11 with the power control unit 7 to discharge the cooling liquid from the radiator 11. A second electric pump 28 is provided in the second cooling liquid discharge pipe 27. In the second cooling circuit 25, the cooling liquid pumped by the second electric pump 28 to circulate in the circuit absorbs heat from the power control unit 7 and dissipates heat to ambient air (exchanges heat with ambient air) at the radiator 11, to thereby cool the power control unit 7.

Further provided in the engine room 3 is a third cooling circuit 30 for cooling air conditioning coolant used in the air conditioner 8. The third cooling circuit 30 includes a coolant feed pipe 31 connecting an evaporator of the air conditioner 8 with the air conditioning condenser 12 to feed the air conditioning coolant to the air conditioning condenser 12, and a coolant discharge pipe 32 connecting the air conditioning condenser 12 with the evaporator of the air conditioner 8 to discharge the coolant from the air conditioning condenser 12. A compressor 33 is provided in the coolant feed pipe 31. In the third cooling circuit 30, the coolant that is compressed by the compressor 33 and circulates in the circuit dissipates heat to ambient air (exchanges heat with ambient air) and is condensed (or liquefied) at the air conditioning condenser 12, and is evaporated at the evaporator of the air conditioner 8 to absorb heat to thereby cool the air in the passenger compartment 6.

Further, a control unit 35 is provided in the engine room 3. The control unit 35 controls output of the engine 4, and in addition, controls operation of the power control unit 7 that relates to control of output of the electric motor 5. The control unit 35 also controls operation of the first electric pump 23, the second electric pump 28, the compressor 33, and the radiator fan 13.

Specifically, the control unit 35 controls circulation of the cooling liquid in the first cooling circuit 20 by controlling operation of the first electric pump 23 such that the temperature of the cooling liquid flowing through the first cooling circuit 20 is lower than or equal to a predetermined first target temperature (e.g., 90° C.). The control unit 35 also controls circulation of the cooling liquid in the second cooling circuit 25 by controlling operation of the second electric pump 28 such that the temperature of the cooling liquid flowing through the second cooling circuit 25 is lower than or equal to a predetermined second target temperature (e.g., 60° C.) which is lower than the first target temperature. Further, the control unit 35 controls operation of the radiator fan 13 such that the first target temperature of the first cooling circuit 20 and the second target temperature of the second cooling circuit 25 are attained. The control unit 35 controls operation of the compressor 33 in accordance with air conditioning instruction input by operation of an input device by a vehicle passenger.

Further, the first cooling circuit 20 may be provided with solenoid valves to be controlled by the control unit 35 to switch the flow path of the cooling liquid in the first cooling circuit 20 depending on conditions, such that the flow path may selectively include a passage passing through the engine 4 or a passage not passing through the engine 4, and a passage passing through the electric motor 5 or a passage not passing through the electric motor 5, for example. The flow path may be switched to selectively bypass the radiator 11. It is also possible to provide thermostats in place of or in addition to the solenoid valves in the first cooling circuit 20 such that the temperature of the cooling liquid is controlled substantively by switching of the flow path by the thermostats and/or the solenoid valves. Further, in another embodiment, an engine driven pump may be provided in place of the first electric pump 23. In such a case also, the temperature of the cooling liquid in the first cooling circuit 20 can be controlled by switching the flow path of the cooling liquid using the thermostats and/or solenoid valves.

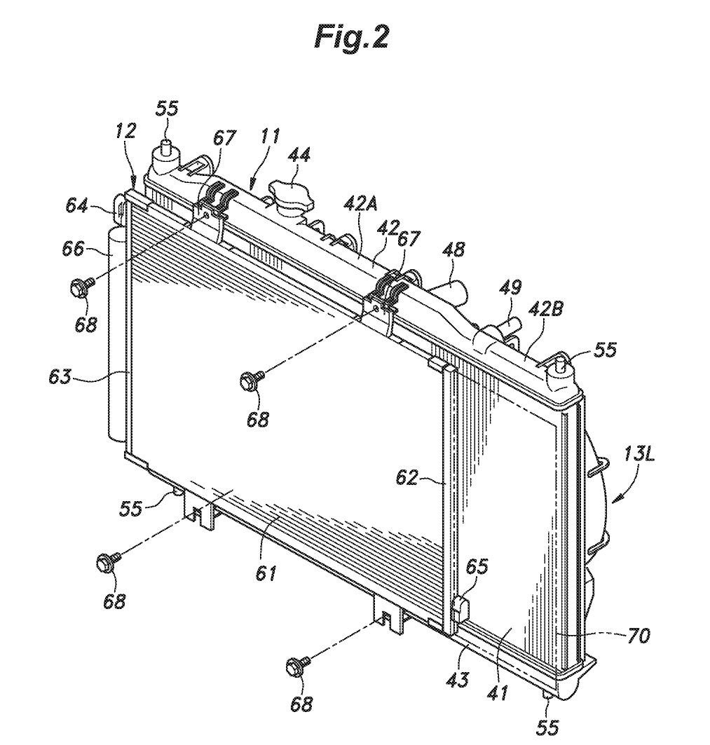

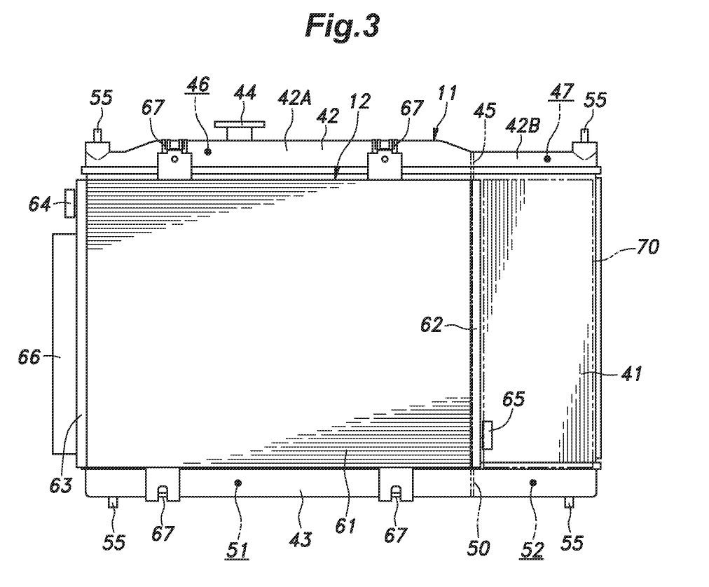

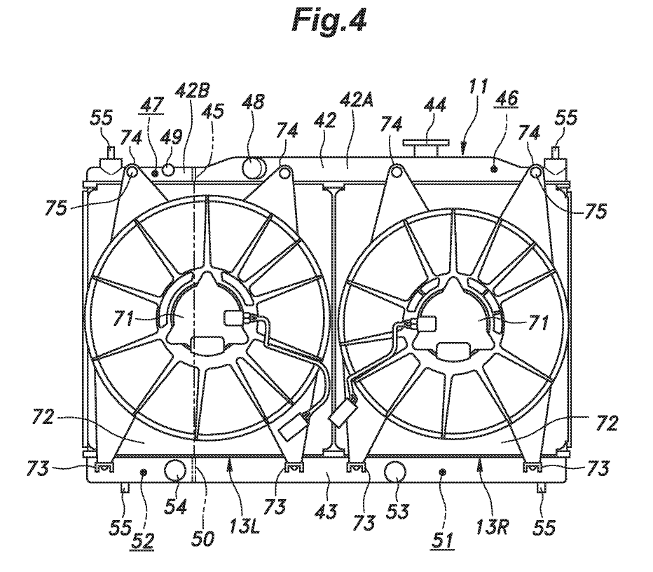

Next, the cooling structure will be described in detail. FIG. 2 is a perspective view of a main part of the cooling structure shown in FIG. 1, FIG. 3 is a front view of the cooling structure shown in FIG. 2, and FIG. 4 is a rear view of the cooling structure shown in FIG. 2. As shown in FIGS. 2 to 4, the radiator 11 is a heat exchanger provided with a radiator core 41 constituting a substantially plate-shaped structural body for cooling the cooling liquid. The term “substantially plate-shaped” means that the structural body may be formed with many passages for allowing air to flow therethrough, but the outer profile of the structural body has a plate shape.

The radiator core 41 has a laterally elongated rectangular shape having a lateral dimension greater than the vertical dimension thereof (approximately twice the vertical dimension in the illustrated embodiment), and extends along a plane facing in the fore and aft direction. The radiator core 41 is provided with a plurality of tubes extending vertically and arranged next to one another laterally such that the cooling liquid flows through the tubes, and heat dissipating fins formed integrally on outer surfaces of the tubes. The radiator core 41 constitutes a unitary structural body, but air can flow from front to rear of the radiator core 41 through gaps (passages) defined between the tubes. In the radiator core 41, heat is dissipated from the cooling liquid flowing through the tubes to ambient air mainly via the fins (namely, heat is exchanged between the cooling liquid and ambient air). Thus, the radiator core 41 constitutes a heat dissipating portion for dissipating heat from the cooling liquid to ambient air through heat exchange between the cooling liquid and ambient air.

An upper tank 42 is provided at an upper end of the radiator core 41, and a lower tank 43 is provided at a lower end of the same. An internal space of the upper tank 42 and an internal space of the lower tank 43 are in communication with each other via cooling liquid passages defined by the tubes of the radiator core 41. The radiator 11 is of a down flow type. Namely, the cooling liquid is supplied to the upper tank 42 from outside, is distributed to the tubes from the upper tank 42, flows through the tubes downward, joins together in the lower tank 43, and is discharged from the lower tank 43 to outside.

The upper tank 42 includes a main body portion 42A occupying a large part of the upper tank 42 including the right half and formed to have a substantially uniform cross section, and a small cross-section portion 42B located at a left end thereof and formed to have a cross section that is lower and smaller than the cross section of the main body portion 42A. The main body portion 42A of the upper tank 42 is integrally formed with a tubular portion defining a cooling liquid replenishment port, which is closed by a radiator cap 44 attached to the tubular portion.

As shown in FIGS. 3 and 4, at a connecting part between the main body portion 42A and the small cross-section portion 42B of the upper tank 42, namely, at a position offset to the left from the lateral center of the upper tank 42, an upper partition wall 45 is provided to partition the internal space of the upper tank 42 laterally. Thereby, the interior of the upper tank 42 is divided into a relatively large first chamber 46 which is located on the right side and defined in the main body portion 42A and a relatively small second chamber 47 which is located on the left side and defined in the small cross-section portion 42B.

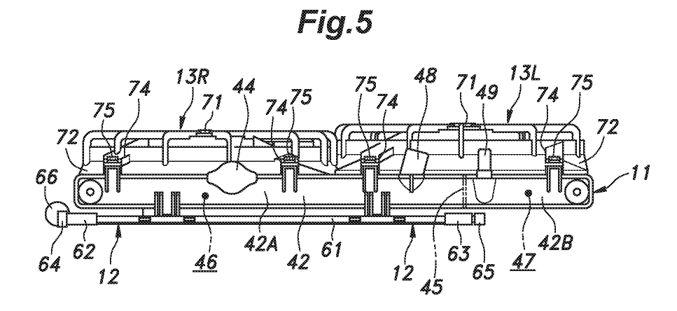

As shown in FIGS. 2 and 4, a part of the main body portion 42A of the upper tank 42 offset to the left from the lateral center of the main body portion 42A is integrally formed with an upper first fitting 48 for connection to a pipe. The upper first fitting 48 defines a cooling liquid inlet for introducing the cooling liquid into the first chamber 46 of the upper tank 42, and extends from the rear part of the upper tank 42 obliquely leftward toward the rear (see FIG. 5 also). In other words, the upper first fitting 48 is inclined relative to the fore and aft direction in such a manner that the upper first fitting 48 extends obliquely away from the second chamber 47 toward the front. The first cooling liquid feed pipe 21 of the first cooling circuit 20 is connected to the upper first fitting 48. Namely, the upper first fitting 48 constitutes a downstream end portion of the first cooling liquid feed pipe 21.

A part of the small cross-section portion 42B of the upper tank 42 offset to the right from the lateral center of the small cross-section portion 42B is integrally formed with an upper second fitting 49 for connection to a pipe. The upper second fitting 49 defines a cooling liquid inlet for introducing the cooling liquid into the second chamber 47 of the upper tank 42 and extends rearward from the rear part of the upper tank 42, where the cooling liquid inlet defined by the upper second fitting 49 has a cross section smaller than that defined by the upper first fitting 48. The second cooling liquid feed pipe 26 of the second cooling circuit 25 is connected to the upper second fitting 49. Namely, the upper second fitting 49 constitutes a downstream end portion of the second cooling liquid feed pipe 26.

The lower tank 43 is formed to have a substantially uniform cross section. At a part of the lower tank 43 directly below the upper partition wall 45, namely, at a part of the lower tank 43 aligned with the upper partition wall 45 in the lateral direction, a lower partition wall 50 is provided to partition the internal space of the lower tank 43 laterally. Thereby, the interior of the lower tank 43 is divided into a relatively large first chamber 51 located on the right side and a relatively small second chamber 52 located on the left side.

As shown in FIG. 4, a part of the lower tank 43 corresponding to a laterally central part of the first chamber 51 is integrally formed with a lower first fitting 53 for connection to a pipe. The lower first fitting 53 defines a cooling liquid outlet for discharging the cooling liquid from the first chamber 51 of the lower tank 43, and extends rearward from the rear part of the lower tank 43. The first cooling liquid discharge pipe 22 of the first cooling circuit 20 is connected to the lower first fitting 53. Namely, the lower first fitting 53 constitutes an upstream end of the first cooling liquid discharge pipe 22.

A part of the lower tank 43 corresponding to a right part of the second chamber 52 is integrally formed with a lower second fitting 54 for connection to a pipe. The lower second fitting 54 defines a cooling liquid outlet for discharging the cooling liquid from the second chamber 52 of the lower tank 43 and extends rearward from the rear part of the lower tank 43, where the cooling liquid outlet defined by the lower second fitting 54 has a cross section smaller than that defined by the lower first fitting 53. The second cooling liquid discharge pipe 27 of the second cooling circuit 25 is connected to the lower second fitting 54. Namely, the lower second fitting 54 constitutes an upstream end of the second cooling liquid discharge pipe 27.

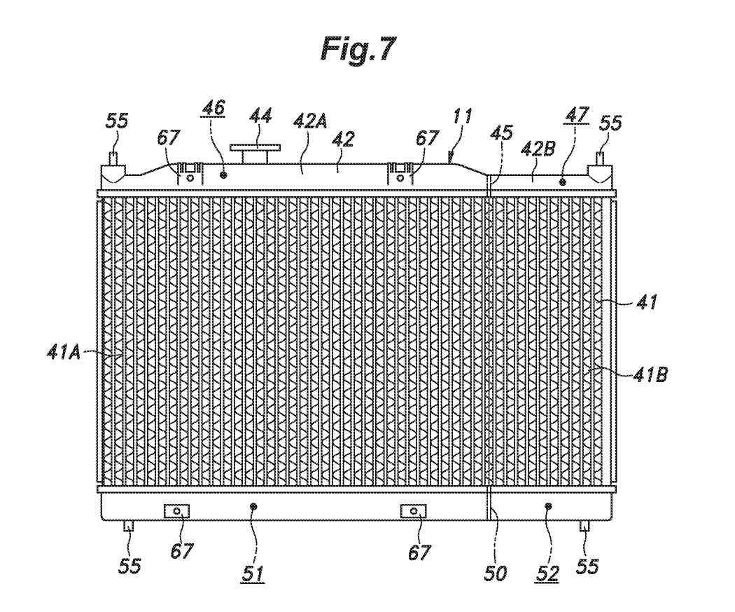

FIG. 7 is a front view of the radiator 11 shown in FIG. 3. As shown in FIG. 7, the first chamber 46 of the upper tank 42 and the first chamber 51 of the lower tank 43 are in communication with each other via some of the tubes of the radiator core 41 located on the right side. The second chamber 47 of the upper tank 42 and the second chamber 52 of the lower tank 43 are in communication with each other via remaining ones of the tubes of the radiator core 41 located on the left side. Namely, the radiator 11 is functionally divided into two portions by the upper partition wall 45 and the lower partition wall 50, which are provided at positions aligned with each other in the lateral direction. In the radiator core 41 which is constructed unitarily, a functional portion associated with the first chambers 46 and 51 constitutes a first heat dissipating portion 41A for the first cooling circuit 20 that cools the engine 4 and the electric motor 5, and a functional portion associated with the second chambers 47 and 52 constitutes a second heat dissipating portion 41B for the second cooling circuit 25 that cools the power control unit 7.

In other words, the upper partition wall 45 and the lower partition wall 50 are respectively provided in the upper tank 42 and the lower tank 43 at a position corresponding to a boundary between the first heat dissipating portion 41A and the second heat dissipating portion 41B. Thus, by providing the upper partition wall 45 and the lower partition wall 50, the radiator 11 (or the radiator core 41) can be divided into two functional portions. Because the upper tank 42 and the lower tank 43, each being formed as a single component, can be used commonly for the two functional portions, the number of components can be decreased, which in turn reduces the cost.

As shown in FIGS. 2 to 4, left and right ends of the upper tank 42 and left and right ends of the lower tank 43 are integrally formed with respective support portions 55 each having a pin-like shape. These support portions 55 are attached to the bulkhead of the vehicle body 2 via stays, whereby the radiator 11 is supported by the vehicle body 2.

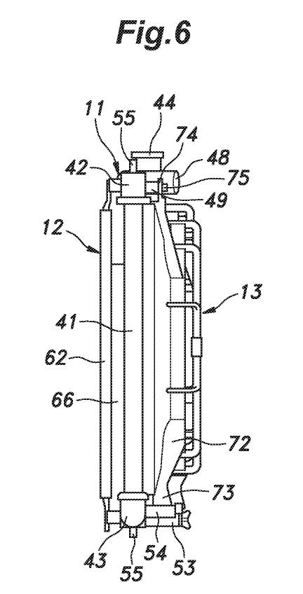

FIG. 5 is a plan view of the cooling structure shown in FIG. 2, and FIG. 6 is a left side view of the cooling structure shown in FIG. 2. As shown in FIGS. 2, 3, 5, and 6, the air conditioning condenser 12 includes a condenser core 61 constituting a substantially plate-shaped structural body configured to cool the air conditioning coolant. The condenser core 61 is disposed in front of the radiator 11 to be substantially in parallel with the radiator 11 and to overlap with a part of the radiator 11 as seen in the fore and aft direction.

The condenser core 61 has a laterally elongated rectangular shape having a vertical dimension substantially the same as that of the radiator core 41 and a lateral dimension smaller than that of the radiator core 41, and extends along the plane facing in the fore and aft direction. The condenser core 61 is provided with a plurality of tubes extending laterally and arranged next to one another vertically such that the air conditioning coolant flows through the tubes, and heat dissipating fins formed integrally on outer surfaces of the tubes. The condenser core 61 constitutes a unitary structural body, but air can flow from front to rear of the condenser core 61 through gaps defined between the tubes. In the condenser core 61, heat is dissipated from the air conditioning coolant flowing through the tubes to ambient air mainly via the fins (namely, heat is exchanged between the coolant and ambient air). Thus, the condenser core 61 constitutes a heat dissipating portion for dissipating heat from the air conditioning coolant to ambient air through heat exchange between the coolant and ambient air.

A pair of left and right header tanks 62, 63 are provided at respective lateral ends of the condenser core 61. Internal spaces of the header tanks 62, 63 are in communication with each other via cooling liquid passages defined by the tubes of the condenser core 61. An upper part of the right header tank 63 is provided with an introduction connector 64 for introducing the coolant from outside. A downstream end portion of the coolant feed pipe 31 of the third cooling circuit 30 is connected to the introduction connector 64. A lower part of the left header tank 62 is provided with a discharge connector 65 for discharging the coolant. An upstream end of the coolant discharge pipe 32 of the third cooling circuit 30 is connected to the discharge connector 65.

A receiver tank 66 is connected to the right header tank 63 to receive the coolant cooled in an upper part of the condenser core 61, separates the received coolant into gas and liquid, and removes dust or the like therefrom. The liquid coolant separated in the receiver tank 66 is returned to the condenser core 61 to be further cooled while flowing through a lower part of the condenser core 61 (subcooling), and is discharged to the coolant discharge pipe 32 via the discharge connector 65.

As shown in FIGS. 2 and 3, each of the upper tank 42 and the lower tank 43 is integrally formed with a pair of support brackets 67 at left and right portions thereof, and the air conditioning condenser 12 is fastened to the support brackets 67 by means of threaded bolts 68 (FIG. 2). Thereby, the air conditioning condenser 12 is mounted to the radiator 11, and the condenser core 61 is disposed at a position where the condenser core 61 substantially overlaps with the first heat dissipating portion 41A of the radiator core 41 and substantially does not overlap with the second heat dissipating portion 41B as seen in the fore and aft direction. Here, the term “substantially overlaps” means that the condenser core 61 may include a part not overlapping with (or cover) the first heat dissipating portion 41A or the first heat dissipating portion 41A may include a part not overlapping with the condenser core 61. Preferably, the condenser core 61 overlaps with 80% or more of the first heat dissipating portion 41A, more preferably, with 90% or more of the first heat dissipating portion 41A, and most preferably, with the entirety of the first heat dissipating portion 41A, as seen in the fore and aft direction. Similarly, the term “substantially does not overlap” means that the condenser core 61 may slightly overlap with a part of the second heat dissipating portion 41B. Preferably, the condenser core 61 overlaps with only 20% or less of the second heat dissipating portion 41B, more preferably, with only 10% or less of the second heat dissipating portion 41B, and most preferably, with no part of the second heat dissipating portion 41B, as seen in the fore and aft direction.

In front of the second heat dissipating portion 41B and at a position aligned with the air conditioning condenser 12 in the fore and aft direction, a protective member 70 is disposed to extend along the plane facing in the fore and aft direction to overlap with the second heat dissipating portion 41B in front view. The protective member 70 has a structure that allows air flow caused by traveling of the vehicle to pass rearward therethrough (e.g., mesh structure), and is mounted to the radiator 11 to substantially cover the entire front side of the second heat dissipating portion 41B. Thereby, the second heat dissipating portion 41B can be protected without its cooling capacity compromised, such that damage to the second heat dissipating portion 41B caused by pebbles or the like kicked up by the vehicle from the road surface is prevented.

On the other hand, the first heat dissipating portion 41A (FIG. 7) is protected by the air conditioning condenser 12 disposed in front of the first heat dissipating portion 41A. Thereby, in the illustrated radiator 11, the entirety of the radiator core 41 which can be easily damaged is protected. It is to be noted that if the radiator 11 is damaged and loses cooling capacity, the temperature of the engine 4, the electric motor 5, and/or the power control unit 7 may increase, which may affect the traveling performance of the automobile 1. On the other hand, if the air conditioning condenser 12 is damaged and loses cooling capacity, it only prevents the air conditioner 8 from operating normally, and does not affect the traveling performance of the automobile 1. Therefore, no protective means is provided in front of the air conditioning condenser 12.

As shown in FIGS. 4 to 6, the radiator fan 13 includes a right radiator fan 13R and a left radiator fan 13L disposed on the rear side of the radiator 11 to be substantially in parallel with the radiator 11 in such a manner that the entirety of the radiator fan 13 overlaps with the radiator core 41 as seen in the fore and aft direction. The right radiator fan 13R and the left radiator fan 13L are general purpose products having substantially the same structure, though they have slightly different sizes and shapes. The right radiator fan 13R is disposed to overlap with a right part of the first heat dissipating portion 41A (FIG. 7) of the radiator core 41. The left radiator fan 13L is disposed to overlap with a left part of the first heat dissipating portion 41A and the second heat dissipating portion 41B (FIG. 7) of the radiator core 41 by extending across the boundary therebetween.

Thus, because the left radiator fan 13L is disposed to overlap with the first heat dissipating portion 41A and the second heat dissipating portion 41B, it is unnecessary to provide fans dedicated for the first heat dissipating portion 41A and the second heat dissipating portion 41B, respectively, and the radiator fan 13 (right and left radiation fans 13R, 13L) can be embodied by general purpose products, which reduces the cost.

Each of the radiator fans 13R, 13L includes a fan motor 71 for driving a fan (blades) and a shroud 72 surrounding the fan. A lower part of the shroud 72 is integrally formed with a pair of lower part support portions 73 each having a downwardly extending mounting pin at the lower end thereof. An upper part of the shroud 72 is integrally formed with a pair of upper part support portions 74 each having a bolt hole. Each radiator fan 13R, 13L is mounted to the radiator 11 by fastening the upper part support portions 74 to mounting portions formed integrally on the upper tank 42 of the radiator 11 using threaded bolts 75 while the lower part support portions 73 are supported on support bases integrally formed on the lower tank 43 of the radiator 11.

The radiator 11 on which the air conditioning condenser 12 and the radiator fan 13 are mounted forms a module, and is mounted to the vehicle body 2. Thereby, it is unnecessary to mount the air conditioning condenser 12 and the radiator fan 13 to the vehicle body 2 individually or the number of steps for the mounting work is reduced. Thus, the mounting of these components to the vehicle body 2 can be achieved easily.

In the cooling structure for the automobile 1 constructed as described above, the radiator 11 includes the first heat dissipating portion 41A configured to cool the cooling liquid for the engine 4 and the electric motor 5 and the second heat dissipating portion 41B configured to cool the cooling liquid for the power control unit 7, as shown in FIGS. 2 and 7. Therefore, it is unnecessary to provide two radiators; one for the engine 4 and the electric motor 5, the other for the power control unit 7, and this reduces the number of components and hence the cost. Further, the first heat dissipating portion 41A and the second heat dissipating portion 41B of the radiator 11 are arranged along the plane facing in the fore and aft direction, and the condenser core 61 of the air conditioning condenser 12 is disposed in front of the radiator 11 to be substantially in parallel with the radiator 11 and overlap with the first dissipating portion 41A of the radiator 11 as seen in the fore and aft direction. Thus, compared to the case where the three heat dissipating portions are respectively provided in separate heat exchangers arranged in a row in the fore and aft direction, the dimension of the cooling structure in the fore and aft direction can be reduced.

In the arrangement where the condenser core 61 is disposed in front of the radiator 11, because the condenser core 61 raises the temperature of ambient air passing therethrough, the cooling capacity of the heat dissipating portion of the radiator 11 located behind the condenser core 61 is lowered. In the present embodiment, as shown in FIGS. 3 and 7, the condenser core 61 is disposed at a position where the condenser core 61 substantially overlaps with the first heat dissipating portion 41A and substantially does not overlap with the second heat dissipating portion 41B as seen in the fore and aft direction. As a result, the cooling capacity of the second heat dissipating portion 41B is higher than the cooling capacity of the first heat dissipating portion 41A. Therefore, even if the second target temperature (e.g., 60° C.) of the second heat dissipating portion 41B is lower than the first target temperature (e.g., 90° C.) of the first heat dissipating portion 41A as described above, the second heat dissipating portion 41B can attain the second target temperature easily.

In the above embodiment, the condenser core 61 is configured such that air conditioning coolant flows therethrough. On the other hand, each of the first heat dissipating portion 41A and the second heat dissipating portion 41B of the radiator 11 is configured such that cooling liquid flows therethrough. Therefore, even if damage is caused to the radiator 11 resulting in mixture of the cooling liquids (such as when the partition wall 45 or 59 is broken), an adverse effect caused thereby is small compared to a case where one of the coolants for the first and second heat dissipating portions 41A and 41B is gas. Further, because the cooling liquid for the power control unit 7 is caused to flow through the second heat dissipating portion 41B having a high cooling capacity, the power control unit 7 can be maintained at a temperature lower than that of the engine 4.

As shown in FIGS. 2 to 5, the upper first fitting 48 is provided at a part of the first chamber 46 of the upper tank 42 offset toward the second chamber 47 and is inclined relative to the fore and aft direction in such a manner that the upper first fitting 48 extends obliquely away from the second chamber 47 toward the front. This allows the first cooling liquid feed pipe 21 to be placed near the second cooling liquid feed pipe 26, to thereby achieve a compact cooling structure. Further, the above arrangement facilitates the cooling liquid to flow to the right part of the first heat dissipating portion 41A located opposite from the direction in which the upper first fitting 48 is offset. Thereby, the cooling liquid can flow evenly through the first heat dissipating portion 41A, and this suppresses reduction in the heat dissipation efficiency that may be caused by offsetting the downstream end portion (upper first fitting 48) of the first cooling liquid feed pipe 21 to the left (toward the second chamber 47).

The concrete embodiment of the present invention has been described in the foregoing, but the present invention is not limited to the embodiment, and may be modified in various ways. For example, in the foregoing embodiment, the electric motor 5 was cooled by the first cooling circuit 20, but the electric motor 5 may be cooled by the second cooling circuit 25 or by another cooling circuit. The concrete structure, arrangement, number, angle, material, etc. of the component parts of the embodiments may be appropriately changed within the scope of the present invention. Also, not all of the component parts shown in the foregoing embodiment are necessarily indispensable, and they may be selectively used as appropriate.

1. A cooling structure for a vehicle, comprising:
a first heat exchanger including a first heat dissipating portion configured to cool coolant for a first device and a second heat dissipating portion configured to cool coolant for a second device, the first and second heat dissipating portions being arranged along a plane facing in a fore and aft direction with respect to the vehicle and constituting a unitary structural body extending along the plane facing in the fore and aft direction; and
a second heat exchanger including a third heat dissipating portion configured to cool coolant for a third device, the third heat dissipating portion extending along the plane facing in the fore and aft direction and being disposed in front of the first heat exchanger to overlap with a part of the first heat exchanger as seen in the fore and aft direction.

2. The cooling structure as defined in claim 1, wherein a target temperature of the second heat dissipating portion is lower than a target temperature of the first heat dissipating portion, and
the third heat dissipating portion is disposed at a position where the third dissipating portion substantially overlaps with the first heat dissipating portion and substantially does not overlap with the second heat dissipating portion as seen in the fore and aft direction.

3. The cooling structure as defined in claim 2, wherein the first heat dissipating portion constitutes a heat dissipating portion configured to cool cooling liquid for an internal combustion engine,
the second heat dissipating portion constitutes a heat dissipating portion configured to cool cooling liquid for a power control unit, and
the third heat dissipating portion constitutes a core of an air conditioning condenser configured to condense air conditioning coolant.

4. The cooling structure as defined in claim 1, wherein the first heat exchanger includes an upper tank provided above the first heat dissipating portion and the second heat dissipating portion and a lower tank provided below the first heat dissipating portion and the second heat dissipating portion, each of the upper and lower tanks has a partition wall provided at a position corresponding to a boundary between the first heat dissipating portion and the second heat dissipating portion to divide an interior of the tank into a first chamber communicating with the first heat dissipating portion and a second chamber communicating with the second heat dissipating portion.

5. The cooling structure as defined in claim 4, wherein one of the upper and lower tanks is connected with a first cooling liquid feed pipe for feeding cooling liquid to the first chamber thereof and a second cooling liquid feed pipe for feeding cooling liquid to the second chamber thereof,
the other of the upper and lower tanks is connected with a first cooling liquid discharge pipe for discharging the cooling liquid from the first chamber thereof and a second cooling liquid discharge pipe for discharging the cooling liquid from the second chamber thereof, and
a downstream end portion of the first cooling liquid feed pipe is connected to a part of the first chamber offset toward the second chamber and is inclined relative to the fore and aft direction in such a manner that the downstream end portion extends obliquely away from the second chamber toward a front.

6. The cooling structure as defined in claim 1, wherein the second heat exchanger is mounted to the first heat exchanger, and the first heat exchanger is mounted to a vehicle body.

7. The cooling structure as defined in claim 1, further comprising a protective member mounted to the first heat exchanger to be located in front of the second heat dissipating portion.

8. The cooling structure as defined in claim 1, further comprising a pair of fans arranged side by side in a lateral direction behind the first heat exchanger, wherein one of the pair of fans located on a side of the second heat dissipating portion overlaps with the second heat dissipating portion and the first heat dissipating portion as seen in the fore and aft direction.
